(19) United States
(12) Patent Application Publication
(10) Pub. No.: US 2019/0127078 A1
(43) Pub. Date: May 2, 2019

(54) METHOD AND SYSTEM FOR IMPROVING AIRCRAFT FUEL EFFICIENCY

(71) Applicant: The Boeing Company, Chicago, IL (US)

(72) Inventors: Geun I. KIM, Woodinville, WA (US); José A. FREGNANI, Sao Jose dos Campos (BR); Tim ROHR, Seattle, WA (US)

(21) Appl. No.: 15/797,118

(22) Filed: Oct. 30, 2017

(51) Int. Cl. B64D 43/00; B64D 37/00; G05D 1/00; G05B 13/04

(52) U.S. Cl. CPC B64D 43/00; G05B 13/04; G05D 1/0005; B64D 37/00

(57) ABSTRACT

A method for improving inflight fuel efficiency of an aircraft includes sensing aircraft fuel weight in the aircraft fuel tanks and reading the fuel weight by a flight management system during aircraft flight; calculating a current center of gravity position from the fuel weight; calculating an aircraft longitudinal trim drag factor from the current center of gravity; and adjusting a fuel burn prediction utilizing the longitudinal trim drag factor. A system for improving aircraft inflight fuel efficiency includes a flight management system programmed to calculate a current center of gravity position from a current aircraft fuel weight, calculate a longitudinal trim drag factor from the current center of gravity, adjust a fuel burn prediction, and display in the flight deck an adjusted fuel burn prediction for each leg of aircraft flight, which is used to adjust aircraft performance automatically by the flight control system or by the pilot.

### TECHNICAL FIELD

The present disclosure relates to flight management systems for aircraft, and more particularly, flight management systems that utilize aircraft and aerodynamic parameters of an aircraft to optimize fuel usage.

### BACKGROUND

Prior to the takeoff of a commercial aircraft, such as a commercial passenger aircraft, the dispatch procedure includes calculating the center of gravity (CG) of the aircraft. The pilot, a member of the flight crew, or other airline personnel calculate the aircraft CG utilize data from published weight and balance tables developed specifically for the aircraft to ensure that the CG is within the flight envelope of the aircraft for the entire flight.

Most commercial aircraft have a central fuel tank, located in the fuselage between the wings, and wing tanks located within the wings. The weights of the fuel in these tanks are used in determining the aircraft CG. During a flight, the CG of the aircraft changes constantly as the fuel in each of these tanks is burned. This inflight CG movement due to fuel burn is computed by the flight management system (FMS) of the aircraft. The aircraft CG movement curve, or fuel vector, is calculated by the FMS from aircraft zero fuel weight (ZFW) to aircraft takeoff weight (TOW). However, this curve typically is not displayed to the pilot or flight crew, and is not in the aircraft's weight and balance tables.

During flight, the aircraft FMS calculates a predictive fuel burn from takeoff to landing. The flightpath of the aircraft is divided into legs separated by waypoints. The waypoints are defined by geographic coordinates and mark the beginning and end of each flight leg. Thus, for each flight leg between two waypoints, there is an associated distance, time, magnetic heading, and fuel burn. The FMS is programmed to calculate predictive fuel burn for each individual leg of the flightpath and display it on the control display unit (CDU) located on the instrument panel in the flight deck.

Changes in the aircraft CG during flight caused by the burning of fuel must be compensated for by changes in the flight control surfaces on the aircraft, which create aerodynamic drag, known as longitudinal trim drag. This kind of drag can be offset somewhat by selecting which fuel tanks to use first, and if available, by actively pumping fuel between separate tanks. Thus, the change in CG during a flight leg changes the trim drag, which affects the predictive fuel burn calculated for that leg. For example, if the CG of an aircraft moves aft during a flight, the trim drag is reduced, which reduces the required fuel burn.

However, rather than use a real-time, current aircraft CG to calculate predictive fuel burn at each waypoint of a flightpath, the FMS uses aircraft performance databases that use the same fixed or reference CG for all waypoints. For example, a reference CG for a particular aircraft may be selected to be fixed at 23.8% aft of the leading edge of the mean aerodynamic chord (MAC) of the wing. Consequently, this value for “cruise CG” (CRZ CG) is a default entry in the flight computer of the FMS, but can be manually overridden by crews in the flight computer of the FMS during the pre-flight procedure. In either case, this value is used by the FMS to calculate maximum altitude and the maneuver margin for each waypoint.

Consequently, there is a need for a flight management system that more accurately reflects the CG of an aircraft during flight in order to calculate an accurate predictive fuel burn, and other performance factors as maximum altitude and maneuver margin.

### SUMMARY

The present disclosure is a method and system for improving aircraft fuel efficiency that uses a real-time calculation of aircraft center of gravity during flight to determine a fuel burn prediction for each leg of a flight. These calculated fuel burn predictions are adjustments from fuel burn predictions based on a static center of gravity and are used to adjust the performance of the aircraft. This results is a more efficient use of fuel and more accurate calculations of maximum altitude and maneuver margins of the aircraft during flight.

In one embodiment, a method for improving fuel efficiency of an aircraft includes sensing a current aircraft fuel weight in fuel tanks of the aircraft during a flight of the aircraft; reading the current aircraft fuel weight by a flight management system; calculating a current center of gravity position of the aircraft from the current aircraft fuel weight by the flight management system; calculating a longitudinal trim drag factor for the aircraft from the current center of gravity position by the flight management system; calculating an adjusted fuel burn prediction for the aircraft utilizing the longitudinal trim drag factor by the flight management system; and adjusting the performance of the aircraft in response to the adjusted fuel burn prediction.

In another embodiment, a method for improving inflight fuel efficiency of an aircraft includes receiving data indicative of a current aircraft fuel weight by flight management system onboard the aircraft during a flight of the aircraft; calculating a current center of gravity position of the aircraft from the current aircraft fuel weight by the flight management system; calculating a longitudinal trim drag factor for the aircraft from the current center of gravity by the flight management system; adjusting a fuel burn prediction for the aircraft using the longitudinal trim factor by the flight management system; and adjusting a performance of the aircraft in response to the fuel burn prediction, either automatically by the flight management system or manually by prompting a pilot of the aircraft.

In yet another embodiment, a system for improving inflight fuel efficiency of an aircraft includes a flight management system that can be connected to receive data indicative of a current aircraft fuel weight during a flight of the aircraft; the flight management system programmed to calculate a current center of gravity of the aircraft from the current aircraft fuel weight, calculate a longitudinal trim drag factor for the aircraft from the current center of gravity, adjust a fuel burn prediction for the aircraft utilizing the longitudinal trim drag factor; and the flight management system includes a display in a flight deck of the aircraft that displays the fuel burn prediction of the aircraft to prompt a pilot to manually adjust a performance of the aircraft; and/or the flight management system is programmed to adjust the performance of the aircraft automatically.

Other objects and advantages of the disclosed method and system for improving aircraft fuel efficiency will be apparent from the following description, the accompanying drawings, and the appended claims.

### BRIEF DESCRIPTION OF THE DRAWINGS

FIG. 1 is a schematic diagram showing the components of an exemplary embodiment of the disclosed system for improving aircraft fuel efficiency in an aircraft;

FIG. 1A is a more detailed schematic representation of the system of FIG. 1;

FIG. 2 is a flow chart showing the disclosed method for improving aircraft fuel efficiency; and

FIG. 3 is a schematic diagram of the aircraft parameters used to calculate the trim drag factor used in the disclosed method and system.

### DETAILED DESCRIPTION

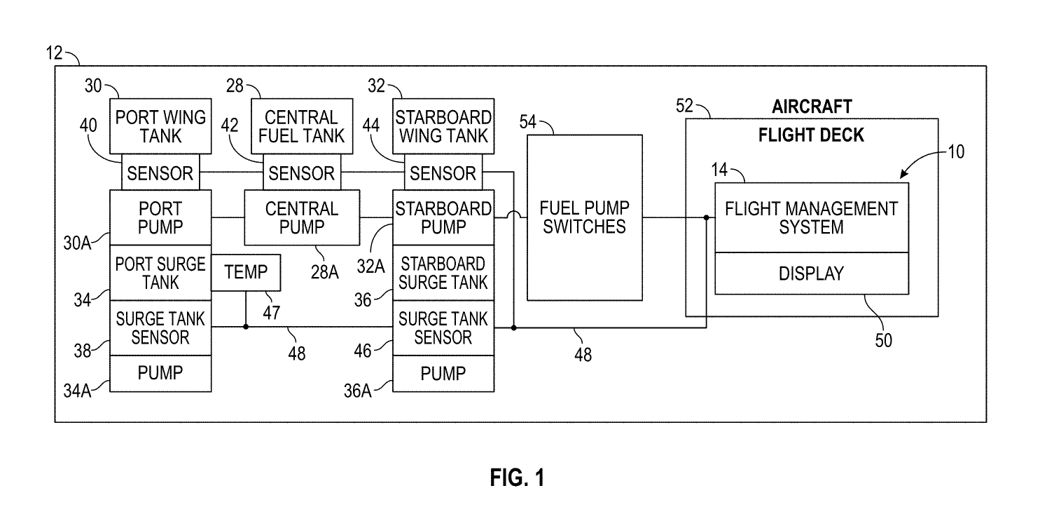

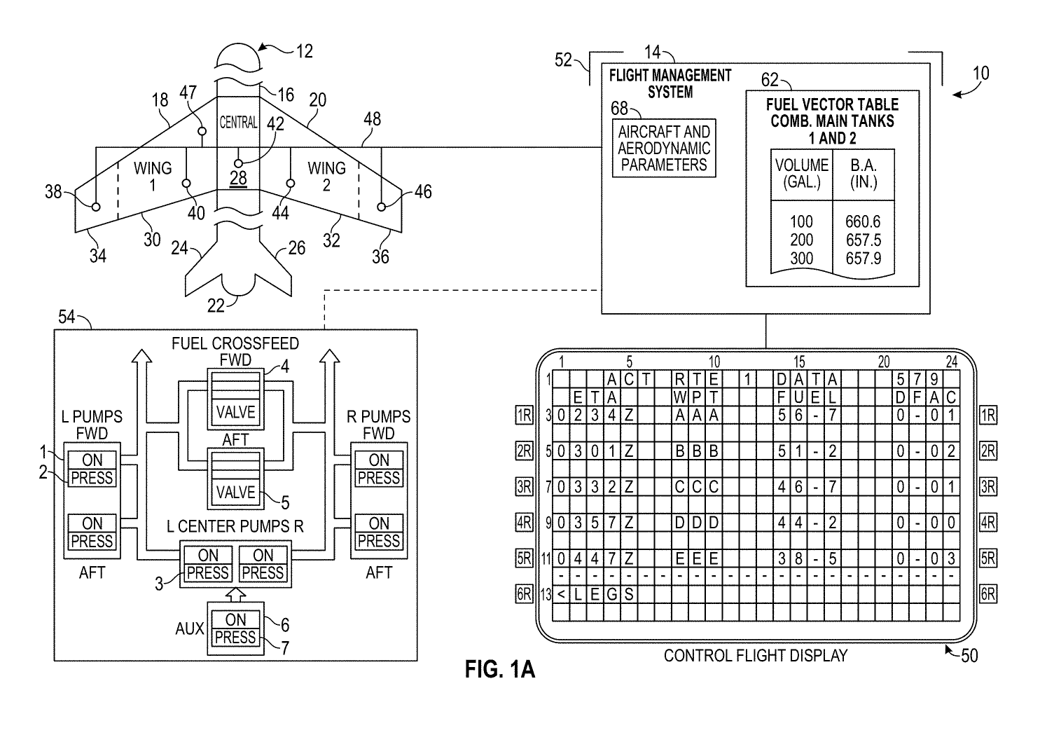

As shown in FIGS. 1 and 1A, a system, generally designated 10, for improving inflight fuel efficiency of an aircraft 12 in an exemplary embodiment includes a flight management system (FMS) 14 that is connected to receive data indicative of current aircraft fuel weight during a flight of the aircraft. The aircraft 12 may take the form of a passenger aircraft, a cargo aircraft, a military aircraft, a civilian or commercial aircraft, or a spacecraft, and may be piloted, flown by the FMS 14, or remotely guided.

The aircraft 12 includes a fuselage 16, port and starboard wings 18, 20, which may or may not be tapered or swept, and a tail assembly 22 having port and starboard horizontal stabilizers 24, 26 and a vertical stabilizer (not shown). The aircraft 12 includes a central fuel tank 28, located within the fuselage 16, and wing tanks 30, 32 located within port and starboard wings 18, 20, respectively. The aircraft optionally includes surge tanks 34, 36, which are an integral part of the wing tanks 30, 32, respectively, located within the wings 18, 20 outboard of the wing tanks 24, 26, respectively. Fuel tanks 28-36 include fuel feed pumps 28A, 30A, 32A, 34A, 36A, respectively, that are actuated by the FMS 14, or manually by the flight crew, to cause fuel to flow from the tanks to the engines of the aircraft 12 during flight, thereby adjusting the aircraft center of gravity.

Fuel sensors 38, 40, 42, 44, 46 are positioned in the port surge tank 34, port wing tank 30, central tank 28, starboard wing tank 32, and starboard surge tank 36, respectively to sense the volume of fuel in each of the tanks. In embodiments, a temperature sensor 47 is located in the port wing 18, and in particular is mounted in the fuel tank 30. Signals from the fuel sensors 38-46 indicative of fuel volume, and a signal from the temperature sensor 47 indicative of fuel temperature are received by the FMS 14, which calculates fuel density, and from the volume and density calculates the fuel mass for each of the tanks 28-36. Fuel sensors 38-46 and temperature sensor 47 are connected to the FMS 14 over an avionics bus 48.

In an exemplary embodiment, the FMS 14 is programmed to calculate a current center of gravity (CG) of the aircraft from the current aircraft fuel weight, calculate a longitudinal trim drag factor for the aircraft from the current CG, and adjust a fuel burn prediction for the aircraft utilizing the longitudinal trim drag factor. The FMS 14 includes a display, which may take the form of a control display unit (CDU) 50, in the flight deck 52 of the aircraft 12. The FMS 14 is programmed to display an adjusted fuel burn prediction of the aircraft 12 on the CDU 50. In one exemplary embodiment, the adjusted fuel burn prediction prompts a pilot to manually adjust a performance of the aircraft. Alternatively, or in addition, the FMS 14 is programmed to adjust the performance of the aircraft 14 automatically.

In an embodiment, the FMS 14 is programmed to adjust a fuel burn prediction continuously during a flight of the aircraft 12, and in particular at least once during each leg of a flightpath of the aircraft. This adjustment may be performed at each waypoint of a flightpath of the aircraft 12. In other embodiments, the FMS 14 is programmed to allow the pilot to override an automatic adjustment of the performance of the aircraft 12. Adjusting the performance of the aircraft can include one or more of adjusting a fuel burn rate, and selectively adjusting fuel flow from tanks 28, 30, 32, 34, 36 by actuating fuel feed pumps 28A, 30A, 32A, 34A, 36A, respectively, also shown schematically on fuel pump control panel 54, which is connected to the FMS 14 and is located in the flight deck 52. For example, in a typical fuel burn sequence the fuel in the central tank 28 is burned first, then one or more of the wing tanks 30-36. A pilot or other member of the fight crew can, instead, elect to burn fuel in one or more of the wing tanks 30, 32, 34, 26 first, then switch to burn fuel from the central tank 28. In still other embodiments, the airline can load more fuel in the central tank 28 and direct pilots and/or the FMS to burn it first, or reduce the amount of fuel loaded (dispatched) onto the aircraft 12 for a given flight, in comparison to an amount of fuel loaded onto an aircraft using a fixed CG calculation, which itself reduces fuel burned and is more economical

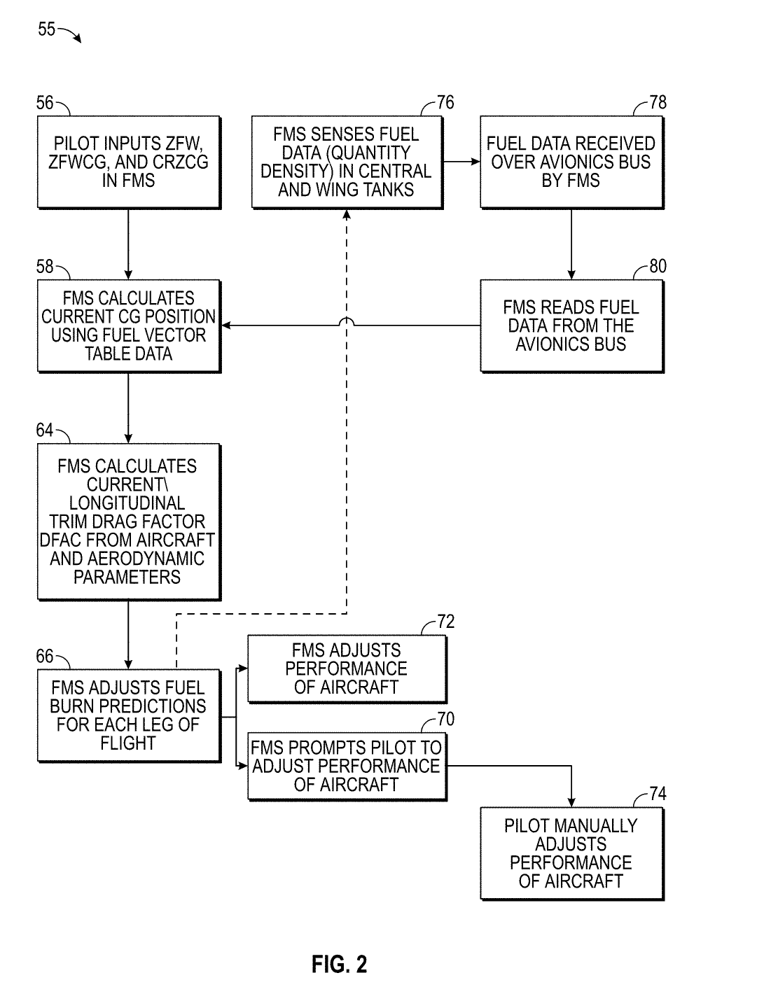

The method for improving fuel efficiency of the aircraft 12 is shown schematically as 55 in FIG. 2. Initially, as part of the pre-flight procedure, the pilot manually inputs values for zero fuel weight (ZFW), zero fuel weight center of gravity (ZFWCG), and cruise CG (CRZCG) into the FMS 12, as shown in block 56. These values are standard for the specific aircraft 12.

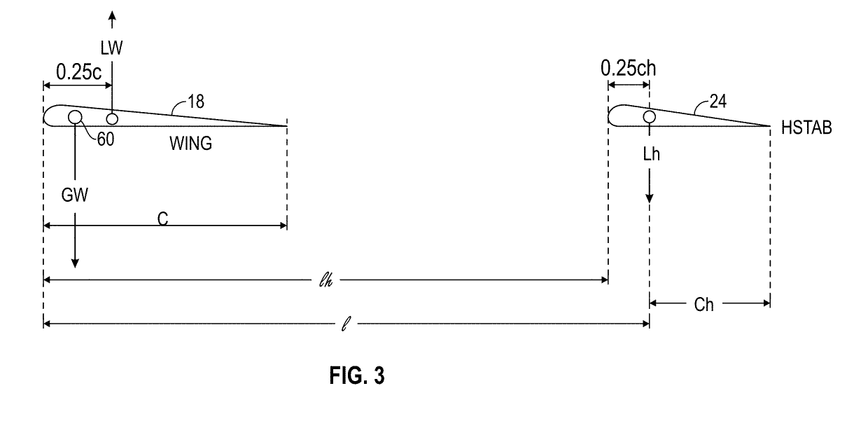

As shown in block 58, after takeoff of the aircraft 12, when at altitude, the FMS 14 calculates the current CG position 60 (FIG. 3) of the aircraft 12 by sensing the current aircraft fuel weight in the fuel tanks 28-36 of the aircraft during a flight of the aircraft, reading the current aircraft fuel weight by the FMS 14, then calculating a current center of gravity position of the aircraft from the current aircraft fuel weight by the FMS. The FMS 14 determines the current CG position 60 of the aircraft 12 using the following calculations. First, the zero fuel weight balance arm (ZFWBA) is determined from the following formula:

ZFWBA=LEMAC+ZFWCG*MAC

where LEMAC is the leading edge mean aerodynamic chord, ZFWCG is the zero fuel weight center of gravity, and MAC is the mean aerodynamic chord (“C” in FIG. 3). Then, the current CG 60 (XCG) of the aircraft 12 is calculated using the following formula:

$$XCG = \frac{ZFWBA * ZFW + WQTYBA * WQTY + CQTYBA * CQTY}{ZFW + WQTY + CQTY}$$

where WQTYBA is fuel balance arm of total fuel quantity in the wings 18, 20, taken from the fuel vector table 62 stored in the FMS 14; WQTY is the fuel volume sensed in the wing tanks 30, 32 (and optionally surge tanks 34, 36) by sensors 38-46; CQTYBA is the fuel balance arm of total fuel quantity in the central tank 28; CQTY is the fuel volume sensed in the central tank. The CG position 60 as a function of a percentage of the MAC (CG %) is calculated using the formula:

$$CG \% = \frac{XCG - LEMAC}{MAC} \times 100$$

Next, as indicated in block 64, the longitudinal trim drag factor (Dfac) for the aircraft 12 is determined from the current CG position 60 by the FMS 14 utilizing a table 68 stored in the FMS 14 of aircraft and aerodynamic parameters for the aircraft 12. The FMS 14 calculates the Dfac using the following formula, and with reference to FIG. 3:

$$Dfac = \frac{{( \frac{GW}{qS} )}^{2}}{( π . A . e . ) ( \frac{l}{c} - 0.25 )} \cdot \frac{( {( cg \text{/} 100 )}^{2} - {( cgref \text{/} 100 )}^{2} - ( \frac{2 lh}{c} ) . ( cg \text{/} 100 - Cref \text{/} 100 ) )}{CDo + \frac{{( \frac{GW}{qS} )}^{2}}{( π . A . e ) ( \frac{lA}{c} - 0.25 )} . {( ( \frac{2 lh}{c} ) - cg \text{/} 100 )}^{2}}$$

where GW is the gross weight of the aircraft 12, cg is the current CG position (% c) expressed in terms of MAC, cgref is the reference CG (% c) for where FMS 14 performance tables are generated, lh is the position of the horizontal stabilizer (HSTAB) 24, c is the wing mean aerodynamic chord (MAC), Ch is the horizontal stabilizer MAC, A is the wing main aspect ratio, S is the wing reference area, e is the Oswald factor, CDo is the zero lift drag (a function of Mach and Reynolds numbers), l is the distance from the leading edge of the wing 18 to the lh, q is the dynamic pressure (0.5*p*V²), and S is the wind area.

As shown in block 66, the FMS 14 next calculates an adjusted fuel burn prediction for the aircraft 12 utilizing the longitudinal trim drag factor Dfac using the following formula:

Wf=Wfref*(1+Dfac)

where Wf is the corrected or adjusted fuel burn between waypoints, and Wfref is the fuel burn between waypoints of the flight path of the aircraft 12 using the standard, fixed CG position for that aircraft.

Once the corrected or adjusted fuel burn Wf is calculated by the FMS 14, the FMS uses or substitutes that value as the fuel burn prediction between waypoints on the flight path. The FMS 14 displays that adjusted fuel burn prediction of the CDU display 50 in the flight deck 52 of the aircraft 12. Accordingly, as indicated in block 70, FMS 14 prompts the pilot to adjust the performance of the aircraft 12 in response to that displayed adjusted fuel burn prediction. Alternatively, as shown in block 72, the FMS 14 adjusts the performance of the aircraft 12.

In exemplary embodiments, as shown in block 74, adjusting the performance of the aircraft 12 manually by the pilot includes one or both of adjusting a fuel burn rate of the aircraft and adjusting aircraft fuel tank usage. In an exemplary embodiment, adjusting the burn prediction includes adjusting the fuel burn prediction for a current leg of a flight path of the aircraft 12 (FIG. 1A). And, adjusting the fuel burn prediction includes sequentially adjusting the fuel burn prediction for each leg of a flight path of the aircraft 12. Adjusting the aircraft fuel tank usage includes selecting a sequence of fuel tanks 28, 30, 32, 34, 36 to be burned by switching on and/or off one or more selected fuel feed pumps 28A, 30A, 32A, 34A, 36A at fuel pump control panel 54. Also in exemplary embodiments, as shown in block 76, sensing aircraft fuel weight by the FMS 14 includes sensing a quantity and a density of the aircraft fuel in the central tank 28 and wing tanks 30-36. The step of sensing aircraft fuel weight includes sensing aircraft fuel weight in each individual tank of the fuel tanks 28, 30, 32, 34, and 36 of the aircraft 12. As indicated in block 78, the FMS 14 receives fuel data over the avionics bus 48, and in block 80, the FMS reads the fuel data from the avionics bus.

Also in exemplary embodiments, the process step of sensing the volume of fuel in the fuel tanks 28, 30, 32, 34, and 36 by sensors 38, 40, 42, 44, and 46, respectively, and the steps performed by the FMS 14 of reading the fuel volume in the individual tanks, then calculating the current center of gravity position cg, then calculating the longitudinal trim drag factor Dfac, and the adjusting the fuel burn prediction Wf, are refreshed every cycle of processor operation of the FMS, as indicated by the dashed line in FIG. 2.

In exemplary embodiments, the step of calculating the current center of gravity position includes reading data from the fuel vector table 62 of the weight and balance manual specific to the aircraft 12, which contained in the FMS 14. The step of calculating the current center of gravity position includes reading data from a table in the FMS 14 including zero fuel weight balance arm, zero fuel weight, fuel balance arm of total fuel quantity in wings 18, 20, fuel volume sensed in wing tanks 30-36, fuel balance arm of total fuel quantity in the central tank 28, and fuel volume sensed in central tank.

The step of calculating the longitudinal trim drag factor Dfac includes the FMS 14 reading data from a table of aircraft and aerodynamic parameters 68, including gross weight, current CG position 60, reference center of gravity position, position of a horizontal stabilizer leading edge main aerodynamic chord with reference to a wing leading edge aerodynamic chord, wing mean aerodynamic chord, horizontal stabilizer mean aerodynamic chord, wind main aspect ratio, wind reference area, Oswald factor, and zero lift drag. The step of adjusting the fuel burn prediction includes the FMS 14 calculating a corrected fuel burn projection from a fuel burn using a standard center of gravity position of the aircraft and the longitudinal trim drag factor Dfac. The step of adjusting the fuel burn prediction includes the FMS 14 calculating a corrected fuel burn projection sequentially for each leg of a flight path of the aircraft. In exemplary embodiments, the FMS 14 automatically adjusts the pitch or trim of the aircraft 12 when the autopilot system, optionally part of the FMS 14 of the aircraft 12, is engaged in response to the changing CG of the aircraft. Alternatively, if the autopilot system is not engaged, the pilot may manually adjust the trim through the pitch trim button in the control column of the flight deck 52.

The disclosed system 10 and method 55 provide a cost savings as well as a performance optimization to aircraft flight by continuously generating accurate, real-time values of predicted fuel burn. The system utilizes current aircraft avionics systems and requires minimal reprogramming of the FMS 14, and therefore is inexpensive to implement.

While the methods and forms of apparatus disclosed herein are preferred embodiments of the disclosed method and system for improving aircraft fuel efficiency, it is to be understood that the invention is not limited to these precise methods and apparatus, and that changes may be made therein without departing from the scope of the invention.

1. A method for improving fuel efficiency of an aircraft, the method comprising:
sensing a current aircraft fuel weight in fuel tanks of the aircraft during a flight of the aircraft;
reading the current aircraft fuel weight by a flight management system;
determining a zero fuel weight balance arm as a sum of a leading edge mean aerodynamic chord plus a zero fuel weight center of gravity multiplied by a mean aerodynamic chord;
calculating a current center of gravity position of the aircraft from the current aircraft fuel weight and the zero fuel weight balance arm by the flight management system;
calculating a longitudinal trim drag factor for the aircraft from the current center of gravity position by the flight management system;
calculating an adjusted fuel burn prediction for the aircraft utilizing the longitudinal trim drag factor by the flight management system; and
adjusting the performance of the aircraft in response to the adjusted fuel burn prediction.

2. The method of claim 1, further comprising displaying the adjusted fuel burn prediction of the aircraft by the flight management system on a display in a flight deck of the aircraft.

3. The method of claim 1, further comprising adjusting a performance of the aircraft by one of the flight management computer and a pilot of the aircraft.

4. The method of claim 3, wherein adjusting the performance of the aircraft includes one or both of adjusting a fuel burn rate of the aircraft and adjusting aircraft fuel tank usage.

5. The method of claim 1, wherein the sensing, the reading, the calculating the current center of gravity, the calculating the longitudinal trim drag factor, and the adjusting the fuel burn prediction are refreshed every cycle of the flight management system.

6. The method of claim 1, wherein adjusting the fuel burn prediction includes adjusting the fuel burn prediction for a current leg of a flight path of the aircraft.

7. The method of claim 6, wherein adjusting the fuel burn prediction includes sequentially adjusting the fuel burn prediction for each leg of a flight path of the aircraft.

8. The method of claim 1, wherein the step of sensing aircraft fuel weight includes sensing a quantity and a density of the aircraft fuel.

9. The method of claim 8, wherein the step of sensing aircraft fuel weight includes sensing aircraft fuel weight in each individual tank of the fuel tanks of the aircraft.

10. The method of claim 1, wherein the step of calculating the longitudinal trim drag factor includes utilizing a position of a horizontal stabilizer and a mean aerodynamic chord of the horizontal stabilizer of the aircraft.

11. The method of claim 1, wherein the step of calculating the current center of gravity position includes reading data from a fuel vector table of a weight and balance manual specific to the aircraft contained in the flight management system.

12. The method of claim 11, wherein the step of calculating the current center of gravity position includes reading data from a table including zero fuel weight balance arm, zero fuel weight, fuel balance arm of total fuel quantity in wings, fuel volume sensed in wing tanks, fuel balance arm of total fuel quantity in central tank, and fuel volume sensed in central tank; and
a. multiplying the zero fuel weight by the zero fuel weight balance arm;
b. multiplying the fuel volume sensed in the wing tanks by the fuel balance arm of total fuel quantity in wings; and
c. multiplying the fuel balance arm of total fuel quantity in central tank by the fuel balance arm of total fuel quantity in central tank;
summing a+b+c and dividing this sum by a sum of the zero fuel weight, the fuel volume sensed in wing tanks and the fuel volume sensed in central tank.

13. The method of claim 12, wherein the step of calculating the longitudinal trim drag factor includes reading data from a table of aircraft and aerodynamic parameters, including gross weight, current center of gravity position, reference center of gravity position, position of a horizontal stabilizer leading edge main aerodynamic chord with reference to a wing leading edge aerodynamic chord, wing mean aerodynamic chord, horizontal stabilizer mean aerodynamic chord, wind main aspect ratio, wind reference area, Oswald factor, and zero lift drag.

14. The method of claim 13, wherein the step of adjusting the fuel burn prediction includes calculating a corrected fuel burn projection from a fuel burn using a standard center of gravity position of the aircraft and the longitudinal trim drag factor.

15. The method of claim 14, wherein the step of adjusting the fuel burn prediction includes calculating a corrected fuel burn projection sequentially for each leg of a flight path of the aircraft.

16. A method for improving inflight fuel efficiency of an aircraft, the method comprising:
receiving data indicative of a current aircraft fuel weight by a flight management system onboard the aircraft during a flight of the aircraft;
calculating a current center of gravity position of the aircraft from the current aircraft fuel weight by the flight management system;
calculating a longitudinal trim drag factor for the aircraft from the current center of gravity by the flight management system including utilizing a position of a horizontal stabilizer of the aircraft;
adjusting a fuel burn prediction for the aircraft using the longitudinal trim factor by the flight management system; and
adjusting a performance of the aircraft in response to the fuel burn prediction.

17. The method of claim 16, wherein adjusting a performance of the aircraft includes one or more of automatically adjusting the performance by the flight management system, prompting a pilot of the aircraft to adjust the performance, and prompting a pilot to override a performance of the aircraft.

18. A system for improving inflight fuel efficiency of an aircraft, the system comprising:
a flight management system that can be connected to receive data indicative of a current aircraft fuel weight during a flight of the aircraft;
the flight management system is programmed to calculate a current center of gravity of the aircraft from the current aircraft fuel weight, calculate a longitudinal trim drag factor for the aircraft from the current center of gravity including utilizing a position of a horizontal stabilizer and a mean aerodynamic chord of the horizontal stabilizer, adjust a fuel burn prediction for the aircraft utilizing the longitudinal trim drag factor; and
the flight management system includes a display in a flight deck of the aircraft that displays the fuel burn prediction of the aircraft to prompt a pilot to manually adjust a performance of the aircraft; and/or
the flight management system is programmed to adjust the performance of the aircraft automatically.

19. The system of claim 18, wherein the flight management system is programmed to adjust a fuel burn prediction continuously during a flight of the aircraft, and in particular at least once during each leg of a flightpath of the aircraft.

20. The system of claim 18, wherein the flight management system is programmed to allow the pilot to override an automatic adjustment of the performance of the aircraft by selectively adjusting fuel flow by first actuating a first fuel feed pump in a central fuel tank of the aircraft followed by actuation of a second fuel feed pump in at least one other aircraft fuel tank.
